(19) United States
(12) Patent Application Publication
(10) Pub. No.: US 2019/0116881 A1
(43) Pub. Date: Apr. 25, 2019

(54) VAPORIZER WITH INLINE USB CONNECTION

(71) Applicants: Hunter Sherwood, San Marcos, CA (US); Jessar Nygard, Westminster, CA (US)

(72) Inventors: Hunter Sherwood, San Marcos, CA (US); Jessar Nygard, Westminster, CA (US)

(73) Assignee: Hermes Therapeutics, LLC, San Marcos, CA (US)

(21) Appl. No.: 15/857,624

(22) Filed: Dec. 29, 2017

Related U.S. Application Data
(63) Continuation-in-part of application No. 29/623,375, filed on Oct. 24, 2017.

(51) Int. Cl. A24F 47/00; H02J 7/00

(52) U.S. Cl. CPC A24F 47/008; H02J 2007/0062; H02J 7/0052

(57) ABSTRACT

A vaporizer includes a rigid rectangular housing having a length, a width, a height, a proximal end, and a distal end. A battery is positioned in the rectangular housing. An inline USB connection is positioned inside the rectangular housing at the proximal end in a fixed position such that the inline USB connection does not extend outside the rectangular housing. The advantageous inline USB connection is an improvement over existing USB connection methods, providing but not limited to fewer components, more stability, more protection, and a streamlined appearance.

### CROSS-REFERENCE TO RELATED APPLICATIONS

The present application is a continuation in part application to U.S. Design patent application Ser. No. 29/623,375, filed on Oct. 24, 2017 entitled “VAPORIZER”, the disclosure of which is hereby incorporated in its entirety at least by reference.

### BACKGROUND OF THE INVENTION

### 1. Field of the Invention

The present invention generally relates to vaporizing devices, but more particularly to a vaporizer with an inline USB connection.

### 2. Description of Related Art

An alternative to smoked tobacco products, such as cigarettes, cigars, or pipes is a personal vaporizer. Inhaled doses of heated and atomized flavor provide a physical sensation similar to smoking. However, because a personal vaporizer is typically electrically powered, no tobacco, smoke, or combustion is usually involved in its operation. For portability, and to simulate the physical characteristics of a cigarette, cigar, or pipe, a personal vaporizer may be battery powered. In addition, a personal vaporizer may be loaded with a nicotine bearing substance and/or a medication bearing substance. The personal vaporizer may provide an inhaled dose of nicotine and/or medication by way of the heated and atomized substance. Thus, personal vaporizers may also be known as electronic cigarettes, or e-cigarettes. Personal vaporizers may be used to administer flavors, medicines, drugs, or substances that are vaporized and then inhaled.

### BRIEF SUMMARY OF THE INVENTION

In one embodiment of the present invention, a vaporizer is provided, comprising a rectangular housing having a first length, a first width, a first height, a proximal end, and a distal end; a rechargeable battery positioned in the rectangular housing; an inline USB connection positioned inside the rectangular housing at the proximal end, wherein the inline USB connection is configured to connect to a USB port to charge the rechargeable battery.

In one embodiment, a cylindrical heating portion attached to the distal end of the rectangular housing via a conic connection. In one embodiment, the cylindrical heating portion includes an opening having 510 internal threads configured to accept a 510 cartridge. In one embodiment, the USB connection is a type-A USB connection. In one embodiment, the first width and the first height of the rectangular housing measures 12 and 4.5 millimeters respectively. In another embodiment, the first length of the rectangular housing does not exceed 10.5 centimeters. In yet another embodiment, the vaporizer has an overall length not exceeding 12 centimeters such that the vaporizer is configured to fit inside a pocket of a user.

In one embodiment, the cylindrical heating portion has a second length, a second width, and a second height, wherein the second width is less than the first width. In another embodiment, an operating button positioned on a front portion of the rectangular housing is provided, wherein the operating button is approximate to the distal end of the rectangular housing. In one embodiment, a light positioned on a front portion of the rectangular housing is provided, wherein the light illuminates when the inline USB connection is connected to the USB port until the rechargeable battery reaches a maximum charge such that when a maximum charge is reached the light turns off. In one embodiment, the rectangular housing is constructed from a rigid material. In another embodiment, an insignia on a front portion of the rectangular housing is provided. In yet another embodiment, the inline USB connection does not extend outside the rectangular housing when connected to the USB port.

In another aspect of the invention, a vaporizer is provided, comprising a rigid rectangular housing having a length, a width, a height, a proximal end, and a distal end; a rechargeable battery positioned in the rectangular housing; an inline USB connection configured to connect to a USB port to charge the rechargeable battery, wherein the inline USB connection is positioned inside the rigid rectangular housing at the proximal end in a fixed position such that the inline USB connection does not extend outside the rigid rectangular housing; and a cylindrical heating portion attached to the distal end of the rigid rectangular housing via a conic connection.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a vaporizer with an inline USB connection according to an embodiment of the present invention;

FIG. 2 is a perspective view of a vaporizer with an inline USB connection according to an embodiment of the present invention;

FIG. 3 is a front view of a vaporizer with an inline USB connection according to an embodiment of the present invention;

FIG. 4 is a side view of a vaporizer with an inline USB connection according to an embodiment of the present invention;

FIG. 5 is a bottom view of a vaporizer with an inline USB connection according to an embodiment of the present invention;

FIG. 6 is a top view of a vaporizer with an inline USB connection according to an embodiment of the present invention;

FIG. 7A is a transparent perspective view of a vaporizer with an inline USB connection according to an embodiment of the present invention;

FIG. 7B is a section view of FIG. 7A taken along section 7B-7B; and

FIG. 7C is a detailed view of FIG. 7A from detail 7C.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a vaporizer with an inline USB connection.

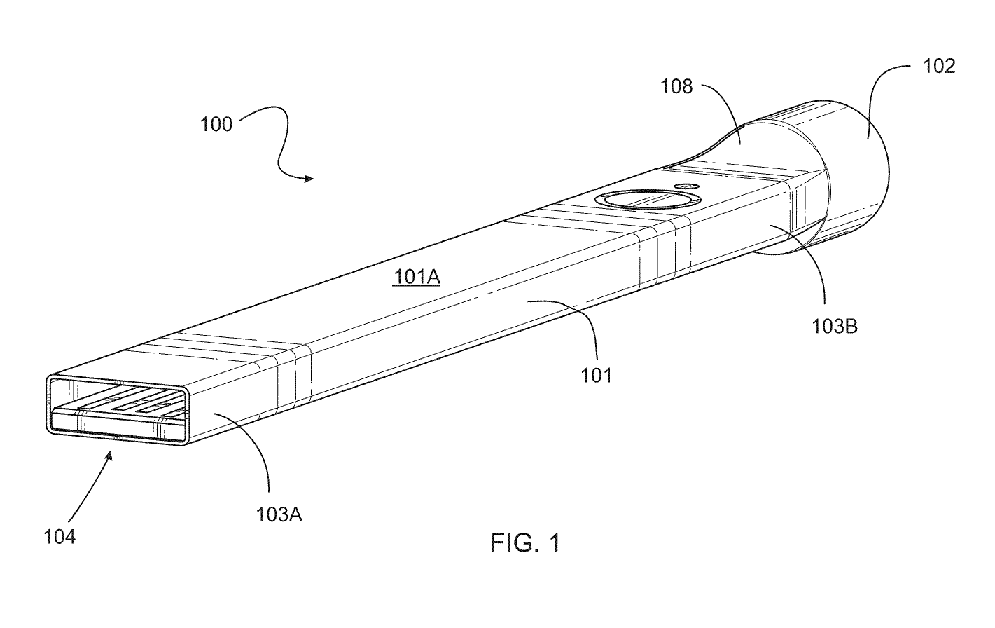

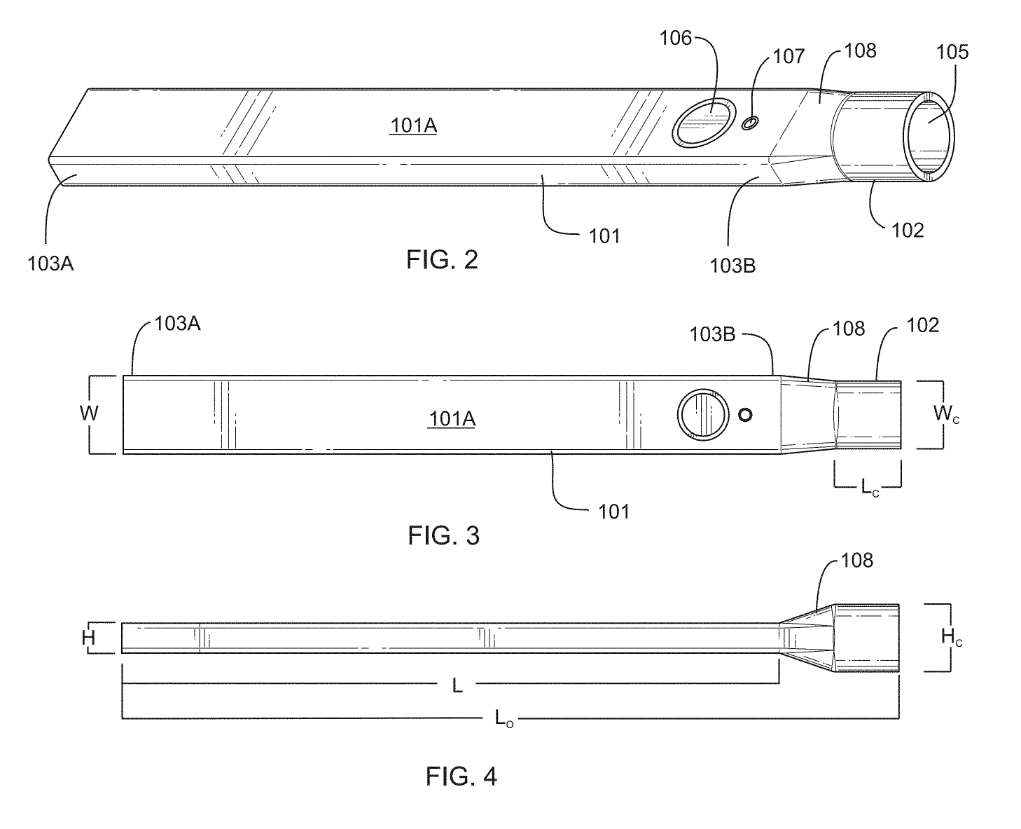

FIGS. 1-7 show various view of a vaporizer 100 with an inline USB connection 104 according to embodiments of the present invention. Referring now to any of the accompanying FIGS. 1-7, the vaporizer is illustrated. The vaporizer comprises a rectangular housing 101 having a length L, a width W, and a height H. The rectangular housing includes a proximal end 103A and a distal end 103B. The rectangular housing is configured to protect electrical components that will be discussed in greater detail below. Preferably, the rectangular housing is constructed from a rigid material.

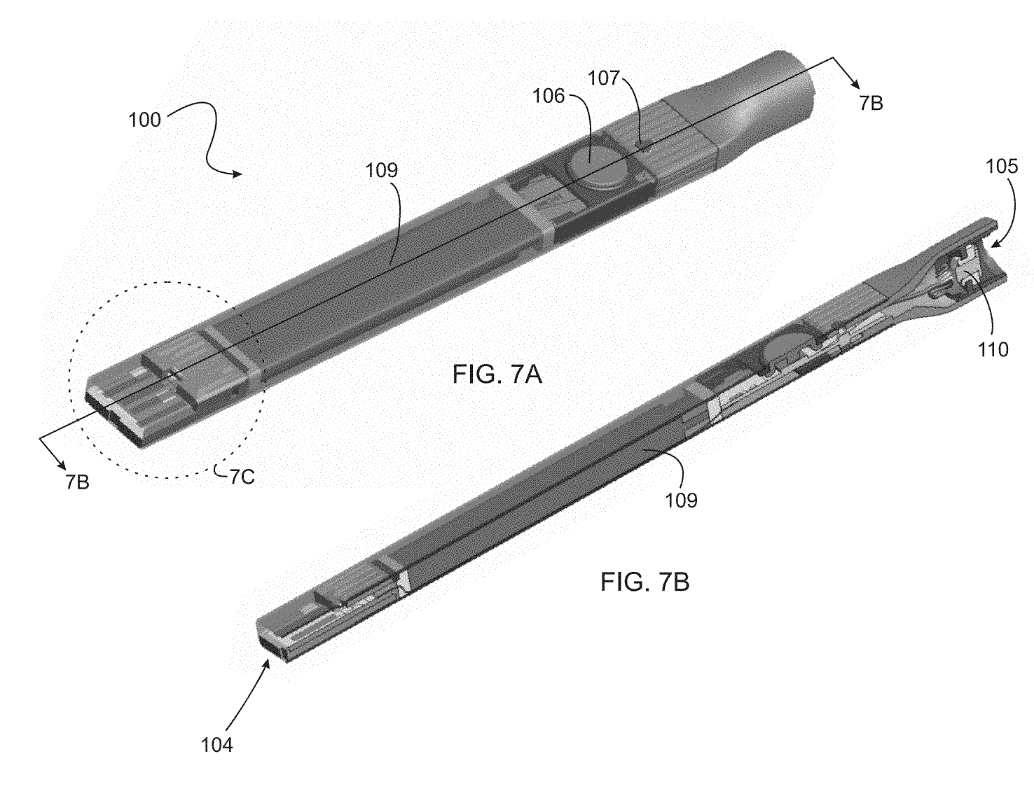

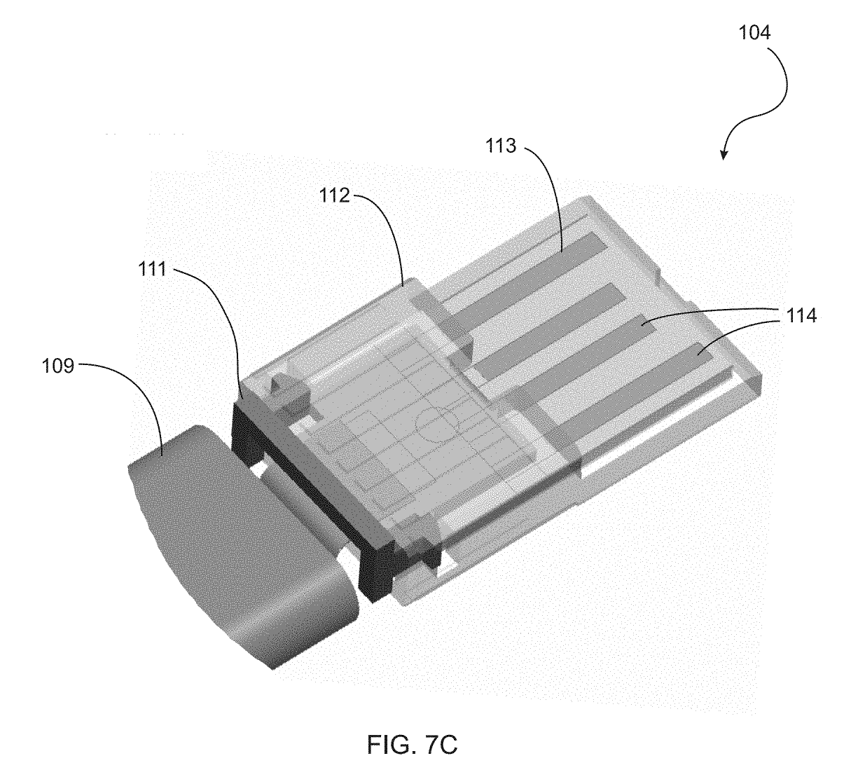

In one embodiment, a Universal Serial Bus (USB) connection 104 is provided on the proximal end of the vaporizer. The USB connection is configured to connect to a USB port (not shown) for charging a battery 109. In one embodiment, the battery is rechargeable, and is constructed from a rectangular shape to match the rectangular housing. It is understood that the battery may be constructed from any shape, however to maximize space efficiency a rectangular battery is preferred. In one embodiment, the USB connection is a type-A USB connection. In one embodiment, the USB connection can supply up to 20V and 5 A to charge the battery. Best seen in FIG. 7C, the USB connection can be seen with the rectangular housing removed, wherein the USB connection includes a USB cover 111, a USB bracket 112, and a connection element 113 having pins 114. The pins located on the connection element connect to corresponding pins located in the USB port as well known in the art. Typically, the USB port is included on a USB power adapter that includes live and natural connections configured to be inserted into a standard home electrical outlet. Some modern electrical outlets provide USB charging ports, thus a USB power adapter is not needed. For the purpose of this disclosure, a USB port may include a USB power adapter configured to be inserted into a standard plug receptacle or a USB port provided directly on an electrical outlet.

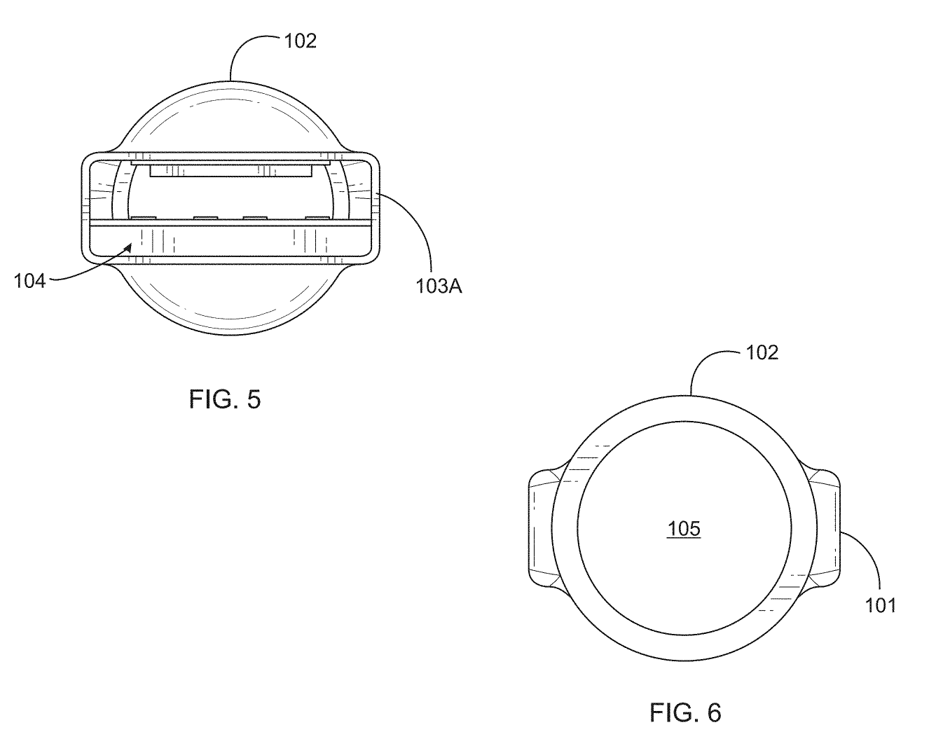

It is a particular advantage of the present invention that rectangular housing is sized and shaped to create an inline USB connection that is streamlined with no visual differences between the proximal and distal ends. For instance, the proximal end of the rectangular housing is configured to fit inside a USB port, as the width W and height H of the rectangular housing measures 12 and 4.5 millimeters respectively, which is the standard width and height for a type-A USB connection. Having a streamlined rectangular housing configured to fit over the USB connection improves the stability of the USB connection. For instance, if the USB connection was a separate component, there would be a risk of the USB connection breaking off from the vaporizer during charging. Integrating the components in an integral housing increases durability. It is critical that the USB connection does not extend outside the rectangular housing when connected to the USB port for charging and storage. The USB connection not visible unless the bottom view (FIG. 5) or a portion of the bottom view of the vaporizer is exposed, such that the USB connection is hidden in the front, back, top, and side views.

In one embodiment, the length L should not exceed approximately 10.5 centimeters and the vaporizer overall length L_{O} should not exceed approximately 12 centimeters as the vaporizer is intended to fit inside a user's pocket. Further, as battery technology improves, and the battery can be smaller, such that length L can decrease. However, it should be understood that the length L and the vaporizer overall length L_{O} should may vary. Width W and height H should be constant as it relates the criticality of the USB connection.

In one embodiment, the vaporizer includes a cylindrical heating portion 102 attached to the rectangular portion via conic connection 108 adjacent to the distal end. The cylindrical heating portion includes opening 105 having 510 internal female threads configured to accept a 510 cartridge (not shown). The cartridge allows a substance to be vaporized during operation as well known in the art. The cartridge includes a mouthpiece allowing the vaporized substance to be inhaled by a user. The cartridge and corresponding mouthpiece is outside the scope of the present invention. Chen, United States Patent Publication Serial Number 2014/0109921A1 and Pevec, Patent Corporation Treaty Application Serial Number PCT/S12016/000001 (Publication Number WO 2016/122417) disclose suitable vaporizer cartridges that may be attached to the present invention during operation, the disclosures of which are hereby incorporated in their entirety, at least by reference.

In one embodiment, the cylindrical heating portion has a length L_{C}, a width W_{C}, and height H_{C}. The dimensions of the cylindrical heating portion may vary, however the width W_{C} and height H_{C} are equal, and the length L_{C} should be as minimized as possible. For instance, as previously mentioned the cylindrical opening includes 510 internal threads, which correlates to 5 millimeters in length with 10 threads. Thus, length L_{C} is at least 5 millimeters, and preferably will not exceed 10 millimeters. In one embodiment, the width W_{C} is less than width W.

In one embodiment, an operation button 106 is positioned on a front portion 101A of the rectangular housing. Preferably, the button is positioned towards the distal end of the housing, as the positioning allows a user to operate the vaporizer ergonomically with one hand. During operation, if button is engaged five consecutive times the battery will turn on. This ensures that the vaporizer does not turn on accidentally in a user's pocket. Once the battery is turned on, heating element 110 inside the cylindrical heating portion is activated. Then, when a predetermined operating temperature is reached, the material inside the cartridge is vaporized, allowing a user to inhale the vapor via the mouthpiece as well known in the art. Similarly, once the battery is on, if the button is engaged five consecutive times the battery will turn off.

In one embodiment, the battery provided has a capacity of between 100-1000 milliamp hours. However, as previously mentioned as battery technology improves, the size and corresponding capacity may be modified depending on electrical requirements and other factors, such as operating temperatures, substance vaporization temperatures, battery charging times, battery life, etc. It is a particular advantage of the present invention that the battery is a rechargeable battery, which may be recharged via the USB connection. When the USB connection is inserted into a USB port as previously described, light 117 illuminates until the battery reaches maximum charge and the charging is complete, at which point the light turns off. Thus a user has an indication of when to remove the USB connection and corresponding vaporizer from the USB port. Preferably, the light is positioned adjacent to the button on the distal end on the front portion of the rectangular housing, however it is understood that the position of the light may vary.

In one embodiment, insignia (not illustrated) is preferably positioned on the front portion of the rectangular housing. The insignia may include company information or product identifying marks specific to the vaporizer. In one embodiment, the color of the vaporizer, including the cylindrical heating portion, the rectangular housing, insignia, and other components may vary. For instance, in one embodiment, the insignia, operation button, and cylindrical heating portion may be one color, such as gold, and the rectangular housing may he a contrasting color, such as black. In another embodiment, all the components may be one color, such as gold, wherein the insignia may be a contrasting color, such as black.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1. A vaporizer comprising:
a rectangular housing having a first length, a first width, a first height, a proximal end, and a distal end;
a rechargeable battery positioned in the rectangular housing;
an inline type A-USB male connection positioned inside the rectangular housing at the proximal end, wherein the inline USB connection is configured to connect to USB female port to charge the rechargeable battery without the use of a charge cable such that the rectangular housing is positioned inside the USB female port.

2. The vaporizer of claim 1, further comprising a cylindrical heating portion attached to the distal end of the rectangular housing via a conic connection.

3. The vaporizer of claim 2, wherein the cylindrical heating portion includes an opening having internal threads configured to accept a cartridge.

4. (canceled)

5. The vaporizer of claim 1, wherein the first width and the first height of the rectangular housing measures 12 and 4.5 millimeters respectively.

6. The vaporizer of claim 5, wherein the first length of the rectangular housing does not exceed 10.5 millimeters.

7. The vaporizer of claim 6, wherein the vaporizer has an overall length not exceeding 12 millimeters such that the vaporizer is configured to fit inside a pocket of a user.

8. The vaporizer of claim 3, wherein the cylindrical heating portion has a second length, a second width, and a second height, wherein the second width is less than the first width.

9. The vaporizer of claim 1, further comprising an operating button positioned on a front portion of the rectangular housing, wherein the operating button is approximate to the distal end of the rectangular housing.

10. The vaporizer of claim 1, further comprising a light positioned on a front portion of the rectangular housing, wherein the light illuminates when the inline type A-USB male connection is connected to the USB female port until the rechargeable battery reaches a maximum charge such that when a maximum charge is reached the light turns off.

11. The vaporizer of claim 1, wherein the rectangular housing is constructed from a rigid material.

12. The vaporizer of claim 1, further comprising an insignia on a front portion of the rectangular housing.

13. The vaporizer of claim I, wherein the inline type A-USB male connection does not extend outside the rectangular housing when connected to the USB female port.

14. A vaporizer comprising:
a rigid rectangular housing having a length, a width, a height, a proximal end, and a distal end;
a rechargeable battery positioned in the rectangular housing;
an inline USB connection configured to connect to a USB port to charge the rechargeable battery, wherein the inline USB connection is positioned inside the rigid rectangular housing at the proximal end in a fixed position such that the inline USB connection does not extend outside the rigid rectangular housing and the rigid rectangular housing is positioned inside the USB port; and
a cylindrical heating portion attached to the distal end of the rigid rectangular housing via a conic connection.
